(19) United States
(12) Patent Application Publication
(10) Pub. No.: US 2013/0031717 A1
(43) Pub. Date: Feb. 7, 2013

(54) SHOWER LINER SYSTEM AND METHOD

(71) Applicants: Denise Roland, Jackson Heights, NY (US); Patricia Murphy, Long Beach, NY (US); Janice Roland, New York, NY (US); Vincent Vaccaro, Long Beach, NY (US)

(72) Inventors: Denise Roland, Jackson Heights, NY (US); Patricia Murphy, Long Beach, NY (US); Janice Roland, New York, NY (US); Vincent Vaccaro, Long Beach, NY (US)

(21) Appl. No.: 13/534,891

(22) Filed: Jun. 27, 2012

Related U.S. Application Data
(60) Provisional application No. 61/514,658, filed on Aug. 3, 2011.

(51) Int. Cl. A47K 3/38; B23P 19/00

(52) U.S. Cl. 4/608; 29/426.5

(57) ABSTRACT

The system of the present application is directed towards a shower liner system including a plurality of layers, each of the plurality of layers including a top portion, the top portion of each of the plurality of layers having a plurality of attachment points, a bottom portion and a line of perforation separating the top portion and the bottom portion, wherein a bottom portion of each of the plurality of layers can be removed without removing the top portion, and wherein the upper portion of each of the plurality of layers are fastened together. The method of the present application is directed towards a method of using a shower liner system.

### RELATED APPLICATIONS

The present invention claims the benefit of U.S. provisional patent application 61/514,658 filed on Aug. 3, 2011, the entire content and disclosure of which is incorporated herein by reference.

### FIELD OF THE DISCLOSURE

The disclosure relates generally to the field of shower liners. More specifically, the present disclosure is directed to a shower liner having a plurality of layers.

### BACKGROUND OF THE DISCLOSURE

Typical shower liner systems have a single layer of plastic or a combination of a single layer of plastic and an external fabric layer. The combination of an inner layer of plastic and external fabric layer is used so that the inner layer protects and does not allow water to contact the external fabric layer. In either system, the problem remains that the single plastic liner that does contact the water gets progressively covered with hard water stains and deposits, as well as soap residue, among other materials.

Typically, as residues and stains build up, individuals wash and apply cleaning solutions to the single plastic liner and eventually have to replace the entire liner by removing it from the bar supporting it. Every time an individual wants to replace the single plastic liner, they must remove several clips, remove the single plastic liner and clip a new single plastic liner to the same bar with the same several clips. This method of replacing the single plastic liner takes a long time. Generally, the individual must remove each of the individual clips, typically about 15 clips or more, dispose of the single plastic liner, hang up the new single plastic liner and reattach each of the clips again.

What is desired is a new shower liner system that can make the replacement of shower liners more efficient.

Embodiments of the present application provide a system that addresses the above and other issues.

### SUMMARY OF THE DISCLOSURE

The system of the present application is directed towards a shower liner system including a plurality of layers, each of the plurality of layers including a top portion, the top portion of each of the plurality of layers having a plurality of attachment points, a bottom portion and a line of perforation separating the top portion and the bottom portion, wherein a bottom portion of each of the plurality of layers can be removed without removing the top portion, and wherein the upper portion of each of the plurality of layers are fastened together.

The method of the present application is directed towards a method of using a shower liner system. The method includes the steps of removing each of the bottom portions of the plurality of layers consecutively from the inner most layer of the plurality of layers to the outer most layer of the plurality of layers, detaching the top portions of each of the plurality of layers from the support and attaching a new plurality of layers to the support, the new plurality of layers having both a top portion and a bottom portion for each of the plurality of layers.

The present disclosure will be better understood by reference to the following drawings of which:

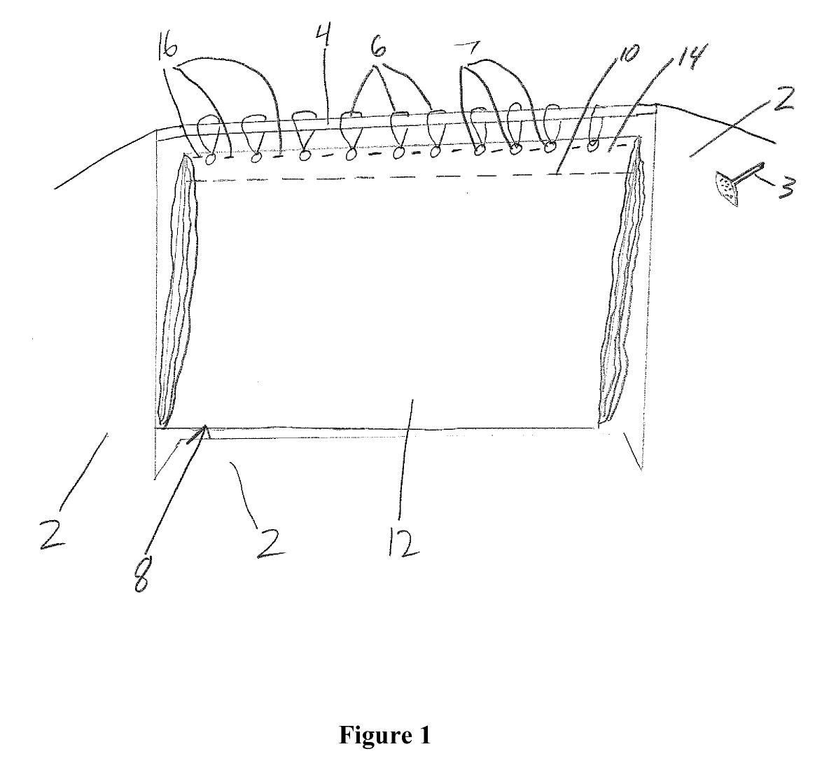

FIG. 1 illustrates a shower liner system viewed from an inner most side of a plurality of layers;

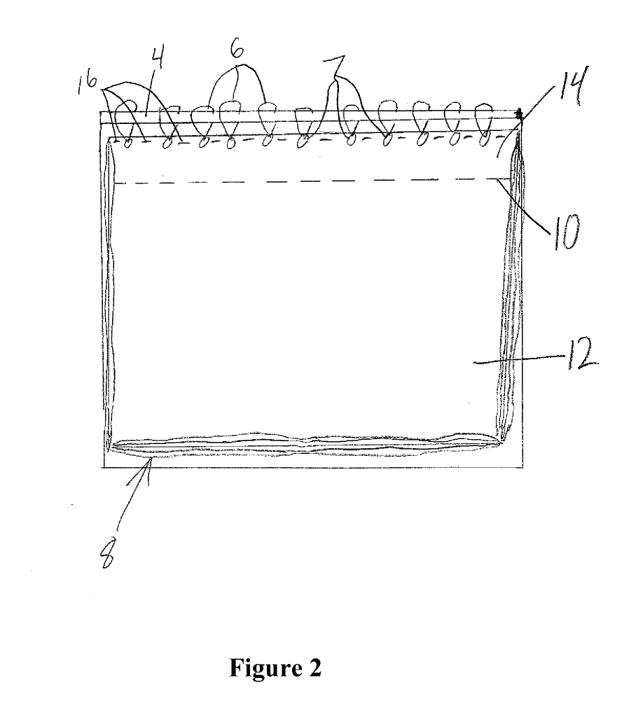

FIG. 2 illustrates a shower liner system viewed from an outer most side of a plurality of layers;

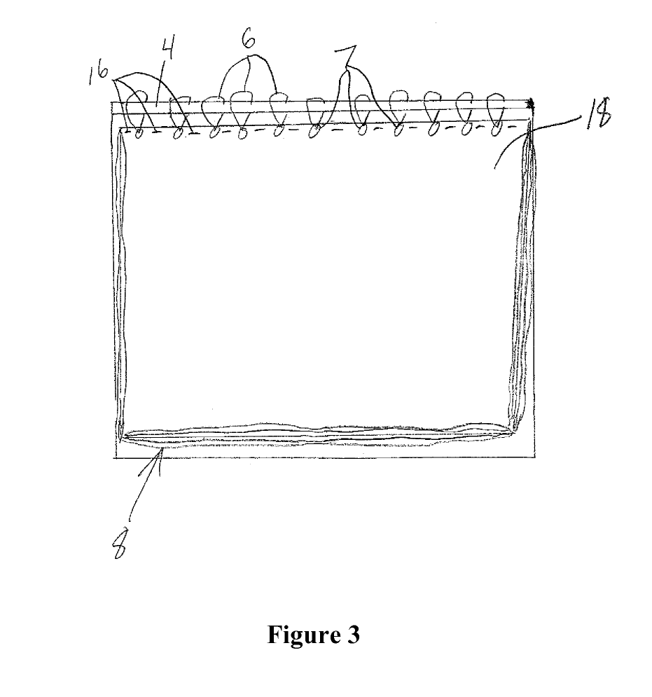

FIG. 3 illustrates a shower liner system viewed from an outer most side of a plurality of layers, wherein a solid outer layer is included.

### DETAILED DESCRIPTION

The present application is directed towards a system of shower liners. Although the system is directed to shower liners, the liners could be applied to any bathroom design, such as standard bathtubs, with or without a shower, hot-tub style tubs or any other bathroom design. One example of a shower system can be seen in FIG. 1 and will be referred to for exemplary purposes.

In FIG. 1, the system is shown as being used in conjunction with a bathtub 2 having a shower nozzle 3. The view of FIG. 1 is shown as if an individual was standing in the bathtub 2, looking at a plurality of layers 8 from an inner most side to an outer most side of the plurality of layers 8. The view of FIG. 2 is shown as if an individual was standing in the room the bathtub 2 was in, looking at the plurality of layers 8 from an outer most side to an inner most side of the plurality of layers 8. As used herein, the term “inner most” refers to the layer of the plurality of layers 8 towards the inside of the bathtub 2, closest to the shower nozzle 3. As used herein, the term “outer most” refers to the layer of the plurality of layers 8 towards the outside of the bathtub 2, exposed to the room the shower is in and not shower nozzle 3. No specific size is contemplated for all systems with each plurality of layers 8 being sufficiently large to substantially block water from shower nozzle 3 from exiting the shower and entering the room the shower is in.

The disclosed system includes the plurality of layers 8, with each of the plurality of layers 8 being about the same size and having a plurality of attachment points 7. The plurality of layers 8 can include any number of layers, with 2 layers being the minimum number of layers. Attachments points 7 allow for attachers 6 to connect to the plurality of layers 8 or pass through each of the plurality of layers 8. Attachment points 7 can be in any shape including circular, square, triangular, oval, vertical slits and horizontal slits, for example. The plurality of attachment points 7 are used to attach the plurality of layers 8 to a support 4, such as a bar. The plurality of layers 8 are attached to the support 4 by attachers 6. Attachers 6 can be any suitable attachment mechanism that can suspend the plurality of layers 8 from the support 4. For example, attachers 6 can be rings, hooks, tabs and the like.

Each of the plurality of layers 8 has a line of separation 10 at about the same height, separating each of the plurality of layers 8 into a bottom portion 12 and a top portion 14. Line of separation 10 can include any suitable design that allows for the separation bottom portion 12 from top portion 14. Line of separation 10 can include a suitable physical connector, including snaps, clips and a tongue and groove connection, among others. Line of separation 10 can also include a line of perforation. This line of perforation is formed by several holes or slits and is shown throughout the figures for illustrative purposes.

Although the line of separation 10 is shown as being substantially straight in FIG. 1, it could be any sufficient shape, such as being angled, having a curve and being sinusoidal. The bottom portion 12 and top portion 14 are separated by the line of separation 10. The top portion 14 of each of the plurality of layers includes attachment points 7 that attach the plurality of layers 8 to the support 4.

After a period of time, an individual can remove the inner most layer of the plurality of layers 8, leaving several more layers still attached to support 4. To remove the inner most layer of the plurality of layers 8 the individual can grasp, with their hands or with a tool such as pliers, the inner most layer of the plurality of layers 8. The individual grasps the bottom portion 12 of the inner most layer of the plurality of layers 8 and pulls the bottom portion 12 so that the bottom portion 12 separates from the top portion 14 of the inner most layer by pulling, disengaging, ripping, or tearing along the line of separation 10. The individual can then dispose of the bottom portion 12 of the previously inner most layer of the plurality of layers 8.

After separation of the bottom portion 12, the bottom portion 12 of the next layer of the plurality of layers 8 is exposed to the shower and shower nozzle 3. After a period of time this process can be repeated until each of the bottom portions 12 of the plurality of layers 8 has been separated. At this point, when all bottom portions 12 of the plurality of layers 8 have been removed, the top portions 14 of each of the plurality of layers 8 will remain, with attachers 7 attaching the top portions 14 of the plurality of layers 8 to the support 4. The attachers 7 can then be released and the top portions 14 of each of the plurality of layers 8 can be disposed. After the top portions 14 of each of the plurality of layers 8 are disposed of, a new plurality of layers 8, with each of the plurality of layers 8 having a plurality of attachment points 7, can be attached to support 4 by attachers 6. This process can be repeated.

The plurality of layers 8 can be composed of any suitable material that is substantially water proof. These suitable materials include but are not limited to plastics, latexes and rubbers. Each of the plurality of layers 8 may be transparent, translucent or opaque, each of the plurality of layers 8 may be colored and each of the plurality of layers 8 may have a texture or have a design on either side.

Each of the top portions 14 of the plurality of layers 8 can be connected to each other, such as by an adhesive between each of the top portions 14 of the plurality of layers 8 or by a plurality of fasteners 16. Fasteners 16 can be any suitable mechanism to fasten each of the top portions 14 of the plurality of layers 8 to each other, such as a staple.

Each of the bottom portions 12 of the plurality of layers 8 can also be connected to each other. Each of the bottom portions 12 may be connected to each other along the bottom edge by a suitable physical connection, including snaps, clips and a tongue and groove connection, among others. Each of the bottom portions 12 may also be connected to each other, such as by an adhesive (e.g. water-resistant adhesive) between each of the bottom portions 12 of the plurality of layers 8. In this instance, when an individual is removing the bottom portion 12 of the inner most layer of the plurality of layers 8, the individual peels the bottom portion 12 of the inner most layer of the plurality of layers 8 from the underlying bottom portion 12 of the plurality of layers 8 and tears or rips the inner most layer of the plurality of layers 8 along the line of separation 10. The bottom portion 12 of the previous inner most layer of the plurality of layers 8 can then be disposed of. This process can be repeated until none of the plurality of layers 8 remain. The system could then be replaced, as described above.

The system of shower liners can further include an outer most layer that is solid and does not include a line of perforation, such as line of separation 10 of FIG. 1. This system can be seen in FIG. 3, which illustrates an outer most layer 18 that does not have perforations. Attachments points 7 allow for attachers 6 to connect to the plurality of layers 8 and the outer most layer 18 or pass through each of the plurality of layers 8 and the outer most layer 18. An adhesive can also be placed between the outer most layer 18 and the outer most layer of the plurality of layers 8.

In the embodiment shown in FIG. 3, when each of the plurality of layers 8 have had their bottom portions 12 removed, the outer most layer 18 can be disposed of along with the top portion 14 of each of the plurality of layers 8, as described above.

What is claimed is:

1. A shower liner system comprising:
a plurality of layers, each of the plurality of layers comprising:
a top portion, the top portion of each of the plurality of layers having a plurality of attachment points;
a bottom portion; and
a line of separation that separates the top portion and the bottom portion, wherein a bottom portion of each of the plurality of layers can be removed without removing the top portion, and wherein the upper portion of each of the plurality of layers are fastened together.

2. The shower liner system of claim 1, further comprising attachers to connect the attachment points to a support.

3. The shower liner system of claim 1, wherein an adhesive is between each of the bottom portions of each of the plurality of layers.

4. The shower liner system of claim 1, further comprising a solid, outer most layer.

5. The shower liner system of claim 4, wherein an adhesive is between the solid, outer most layer and an outer most layer of the plurality of layers.

6. The shower liner system of claim 1, wherein the line of separation is comprised of perforations.

7. The shower liner system of claim 1, wherein the line of separation is comprised of a suitable physical connector.

8. The shower liner system of claim 7, wherein the suitable physical connector comprises at least one of a snap, clip or a tongue and groove connection.

9. A method of using a shower liner system, the shower liner system comprising a plurality of layers, each of the plurality of layers comprising a top portion, the top portion of each of the plurality of layers having a plurality of attachment points, a bottom portion, a line of separation that separates the top portion and the bottom portion, wherein a bottom portion of each of the plurality of layers can be removed without removing the top portion, and wherein the upper portion of each of the plurality of layers are fastened together and attachers to connect the attachment points to a support, the method comprising the steps of:
removing each of the bottom portions of the plurality of layers consecutively from the inner most layer of the plurality of layers to the outer most layer of the plurality of layers;
detaching the top portions of each of the plurality of layers from the support; and
attaching a new plurality of layers to the support, the new plurality of layers having both a top portion and a bottom portion for each of the plurality of layers.

10. The method of using a shower liner system of claim 9, wherein the steps are repeated one or more times.

11. The method of using a shower liner system of claim 9, wherein an adhesive is located between each of the bottom portions of each of the plurality of layers.

12. The method of using a shower liner system of claim 9, further comprising a solid, outer most layer.

13. The method of using a shower liner system of claim 12, wherein an adhesive is between the solid, outer most layer and an outer most layer of the plurality of layers.

14. The method of using a shower liner system of claim 9, wherein the line of separation is comprised of perforations.

15. The method of using a shower liner system of claim 9, wherein the line of separation is comprised of a suitable physical connector.

16. The method of using a shower liner system of claim 15, wherein the suitable physical connector comprises at least one of a snap, clip and a tongue and groove connection.
